(19) United States
(12) Patent Application Publication
(10) Pub. No.: US 2022/0312809 A1
(43) Pub. Date: Oct. 6, 2022

(54) PLANT-BASED FOOD PRODUCTS

(71) Applicant: AuraPea LLC, Richmond, VA (US)

(72) Inventors: Benjamin Todd Pasternak, Maidens, VA (US); Mark Auernheimer, Henrico, VA (US)

(21) Appl. No.: 17/846,417

(22) Filed: Jun. 22, 2022

Related U.S. Application Data
(63) Continuation-in-part of application No. 17/544,452, filed on Dec. 7, 2021.
(60) Provisional application No. 63/140,480, filed on Jan. 22, 2021.
(60) Provisional application No. 63/194,416, filed on May 28, 2021.
(60) Provisional application No. 63/226,439, filed on Jul. 28, 2021.

(51) Int. Cl. A23L 11/00; A23J 3/22; A23L 5/10; A23J 3/08; A23J 3/16

(52) U.S. Cl. CPC A23L 11/05; A23J 3/227; A23L 5/13; A23J 3/08; A23J 3/16; A23V 2002/00

(57) ABSTRACT

A plant-based food product and methods of producing thereof. The plant-based food product may include a gel matrix formed from about 20% to 80% w/w of a liquid and about 15% to 50% w/w of a flour, a plant-derived protein or a combination thereof. The flour and/or plant-derived protein may be pretreated by impregnation and enriched with an additive, an amino acid, a peptide, a protein or a dietary supplement. The gel matrix may be formed by mixing the components, optionally pressurizing the mixture within a cooking container and heating at a maintained temperature to form a gel matrix to provide a plant-based food product that mimics the characteristics of meat fat. The gel matrix may be incorporated into plant-based meats or other non-meat base products as a visual, taste and/or mouthfeel mimicker of fat.

### RELATED APPLICATION

The present application is a continuation-in-part of U.S. Ser. No. 17/544,452 filed Dec. 7, 2021 which claims priority to U.S. Provisional Application No. 63/140,480 filed Jan. 22, 2021, U.S. Provisional Application No. 63/194,416 filed May 28, 2021 and U.S. Provisional Application No. 63/226,439 filed Jul. 28, 2021, the disclosures of which are incorporated by reference in their entireties.

### FIELD OF THE INVENTION

The present invention relates to plant-based food products and processes for their production.

### BACKGROUND

Consumer interest and acceptance of plant-based diets has increased in recent years. Following this trend, the food industry has turned toward vegetable proteins, which may be processed into meat-like products, also known as meat analogs. Interest in meat analogs is rising due to the fact consumers are looking for indulgent, healthy, low environmental impact, ethical, cost-effective, and/or new food products that are perceived as being more environmentally friendly and more healthy. To be commercially viable, these products need to approximate certain aesthetic qualities, such as texture, flavor, color, and nutritional characteristics of specific types of meat.

For example, recent improvements in meat analogs have made possible plant-based burgers that taste and look more like meat than a traditional veggie burger. However, these products utilize hyper-processed ingredients, GMO-based plants as the source, as well as unnecessary additives and fillers to recreate the taste and texture of real meat. For example, current plant-based burgers include methylcellulose, which is the main ingredient in some over-the-counter laxatives and lubricants. Moreover, these products often do not provide a healthier alternative than real meat as they share the same amount of calories and fat and contain even more sodium than their meat counterparts.

### SUMMARY

To this end, in one embodiment the present invention provides for plant-based food products mimicking the characteristics of meat fat that may be used as a fat replacement in meat analogs or other non-meat base products to create a healthier alternative. In another embodiment, the present invention provides for plant-based products mimicking the characteristic of bacon, deli meat (e.g., pastrami, mortadella, ham, etc.), or chicken. The plant-based food product may be a gel matrix formed from about 20% to 80% w/w of a liquid and about 15% to 50% w/w of a flour, a plant-derived protein or a combination thereof. The gel matrix may be formed by mixing the components and optionally pressurizing the mixture within a cooking container. In some embodiments, the gel matrix may be mixed at atmospheric pressure, vacuum pressures or positive pressures. The mixture is heated within the cooking container at a maintained temperature to form a gel matrix to provide a plant-based food product that mimics the characteristics of meat fat or may be a meat analog. The gel matrix may be incorporated into plant-based meats or other non-meat base products as a visual, taste and/or mouthfeel mimicker of fat.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

In accordance with one aspect, a plant-based food product mimicking characteristics of meat fat is provided. In another embodiment, the plant-based foot product mimics bacon, deli meat, burger patties, or chicken. In one embodiment, the plant-based food product is a gel matrix comprised of i) about 20% to 80% w/w of a liquid, and about 15% to 50% w/w of a flour, a plant-derived protein or a combination thereof.

The gel matrix may be comprised of a wide variety of liquids such as water, vinegar, juices, plant-based milk, plant-based liquids, alcoholic beverages and combinations thereof. Suitable plant liquids may include vegetable liquids, such as carrot juice, beet juice, corn milk or brines and liquids as exist in canned vegetables. Examples of plant milk may include grain milk, legume milk, nut milk, seed milk and combinations thereof. In certain embodiments, liquids of the gel matrix may include alcoholic beverages, such as beer, wine, cognac, whiskey, gin and combinations thereof.

In some embodiments, the types of flour may include grain flour including oat, spelt, Kamut, and teff, legume flour including lupin, nut flour, vegetable flour including corn flour, root flour, algae flour, rice flour, seaweed flour, amaranth flour and coconut flour, and combinations thereof. The flour may be in flake form. In a preferred example, the legume flour may be chickpea flour or fava bean flour. Suitable chickpea and fava bean flours are described, for example, in U.S. Pat. Nos. 10,264,805 B2, 10,617,133 B2 and 10,834,941 B2.

In some embodiments, the plant-derived protein may include soy protein, lentil protein, pea protein, seed protein such as sesame seed and sunflower seed, mycoprotein, derivatives and combinations thereof. Examples of plant-derived protein may also include protein powders, such as protein isolates, protein hydrolysates, protein concentrates and combinations thereof. However, some embodiments may incorporate proteins which are not plant-derived, such as whey, casein, collagen, egg protein and combinations thereof.

In some embodiments, the plant-based food product may further include about 1% to 40% w/w of oil. For example, the plant-based food product may comprise between about 4% to 20% w/w of oil. Possible suitable oils include almond oil, avocado oil, mustard oil, canola oil, coconut oil, butter, corn oil, cottonseed oil, flaxseed oil, olive oil, peanut oil, rice bran oil, safflower oil, sesame oil, soybean oil, sunflower oil, grapeseed oil, palm oil, vegetable oil and combinations thereof.

Some embodiments of the plant-based food products may further include conventional gelling agents. Although the present disclosure is trying to avoid many of the conventional gelling agents such as methylcellulose, there may be certain embodiments in which conventional gelling agents may be desirable. Examples of conventional gelling agents may include gelatin, pectin, guar gums, carrageenans, konjac, algin, alginates, agar, locust bean bum, acacia gum, methylcellulose gum, carboxymethylcellulose gum, gum arabic hydroxypropyl methylcellulose gum, microcrystalline cellulose gum, furcelleran gum, gellan gum, ghatti gum, karaya gum, tara gum, tragacanth gum, xanthan gum, and combinations thereof.

Embodiments of the plant-based food product may further include one or more additives. These additives may be used to adjust characteristics such as texture, color, taste, mouthfeel, and may also be used for other purposes such as food preservation and fortification. Examples of possible additives may include antioxidants, extracts, salts, spices such as cardamom, cinnamon, nutmeg, vanilla, anise, and mint and the like, herbs, natural flavors, artificial flavors, cultured products, plant-based heme, colorants, sweeteners, natural preservatives, artificial preservatives, amino acids, fillers, nucleic acids, natural colors, sauces (e.g., salsa, Worcestershire sauce, duck sauce, soy sauce), chopped vegetables, dried vegetables, fruits and the like and combinations thereof.

The flour or the plant-based protein or both may be impregnated and enriched with these additives and with amino acids, peptides, proteins and/or dietary supplements. In one embodiment, the flour or plant-based protein is impregnated and enriched utilizing pressure/vacuum such as described in U.S. Publication No. 2022/051277 A1, the disclosure of which is incorporated by reference in its entirety. Exemplary impregnation liquids include amphiphilic, hydrophilic or lipophilic liquids. Exemplary amino acids include tryptophan, lysine, arginine, methionine, glutamine, citrulline, phenylalanine, threonine, leucine, valine, isoleucine and histidine, and mixtures thereof.

Exemplary dietary supplements may include garlic (native or fermented), aloe vera, milk thistle, turmeric, lavender, coriander, cinnamon, fenugreek, argan, cumin, fennel, aniseed, cumin, wintergreen, basilic, white willow, black current, Scot's pine, camomile, sage, green tea, tea tree, birch water, marigold, thyme, savoury, oregano, marjoram, rosemary, noni, watermelon, echinacea, desmodium artichoke, devil's claw (Harpagophytum), achiote, floral waters, tansy, hops, clove, valerian, Rehmannia glutinosa, liquorice, propolis, honey, Echinacea, grape seed extract, extract of grapefruit, ginger, ginkgo, ginseng, muscade, mistletoe, St. John's wort (Millepertuis), omega 3 or fish fatty acids EPA/DHA, soya extract, green tea, or zeolites.

In another embodiment, the additive may also be derived from hemp or cannabis in the form of a solid, a water-based extract or an oil-based extract. Such extracts are comprised of tetrahydrocannabinol (THC) and other cannabinoids (CBDs) such as cannabinol, cannabinolic acid, cannabidiol, cannabidiolic acid, canabidivarin, cannabidivarinic acid, cannabichromene, cannabichromenic acid, cannabidiolic acid, cannabidivarin, cannabigerol, cannabigerolic acid, and cannabigerivarin, and CBD terpenes such as pinene, linalool, myrcene, limonene, caryophyllene and humulene.

These additions may be used in a formulation that is used as an industrial ingredient (baking, culinary inclusion in entrees, ready meals). Active components added to target a person's consumption (in each serving size) may be utilized in a range of 5 mg to 150 mg of THC, 15 mg to 1000 mg of CBD, and 5 mg to 500 mg CBD terpenes. Advantages for inclusion of the active ingredients in the gel are precise measurement in a manufacturing setting such that the end user (e.g., the bakery) will not need to know detailed formulations. Other advantages are ease of product dosing, averts risk of THC and CBD leaching out of food product (as it is suspended in the gel), minimizes risk of secondhand exposure by end user), reduces heat degradation in cooking, reduces souring flavor in food preparation, extends shelf life, and retain more desired flavors of active components.

The gel matrix may also be dusted after formation with a surface dusting to mimic BBQ, cheese, sour cream, lime, lemon and taco seasoning.

The gel matrix may vary in color depending on its specific application. For example, a lighter color may be highly desired when used as a meat fat replacement in various meat analogs while in other some applications, a specific color of the gel matrix may be desired.

The gel matrix may be ground, sliced, formed, and/or further prepared as an industrial food ingredient or an end product. For example, the gel matrix may be used as a fat substitute in ground or prepared meat analogs and may be mixed in such that it mimics both lean and fat mixes. In some embodiments, the gel matrix may be mixed with plant-based meats to form plant-based food products. The gel matrix may be used as a bakery product like bread and cake. In some embodiments, the gel matrix may be mixed with non-meat base products such as jackfruit, tofu, tempeh and seitan. Examples of possible plant-based food products formed from the gel matrix and non-meat base products may include plant-based french fries containing higher protein amounts than potatoes and plant-derived fat supplements.

One example of a plant-based food product may be a base plant-based meat product containing 15% to 20% of the gel matrix. This base end-product may have a neutral flavor system (e.g., a plant-meat flavor profile) that may be used as a ground meat or chicken. For instance, the plant-based meat product may be used for burger patties, mock chicken breasts, chub forms and tray slabs.

In another embodiment, the gel matrix may be formulated to mimic bacon, breakfast strips, ham, pastrami, pickle loaf, pancetta, prosciutto, mortadella, pepperoni, or other deli meats. Smoke flavors such as natural smoke, artificial smoke and/or poultry-like flavors may be added to provide a cured taste or a chicken taste to the gel matrix. Exemplary levels of smoke flavors are 0.01 to 3% w/w of the gel matrix.

In another embodiment, the cooked gel may be ground into “nuggets” and directly fried. Grind sizes and appropriate flavoring may be made to be like snack-foods CornNuts (origin Peru), Cornick (origin Phillipines), or eiotitos (origin El Salvador)—or in Spain, maíz frito (“fried corn”), quicos (“Frankies”), maíz tostado (“toasted corn”) and pepes (“Joes”).

Colorants may be included at a about 0.01 to 2.0% w/w level so that the gel matrix has color approximating that of desired end product being mimicked. Colorants may be natural additives and include tomatoes, tomato paste, tomato powder, vegetable juice powders (including carrot, beet, radish, and cartinoids), vegetable juices, annatto, paprika, peppers, carmine sources, carotenoids, hibiscus, fruits, fruit extracts, fruit juices, and fruit juice extracts. The selection of other natural colors to achieve the desired visual color will be within the skill of one in the art.

The gel matrix may be formed in a shape utilizing a thermoformer pouch or extrusion equipment. Exemplary shapes include round, square or a d-shaped package that may be sliced, to resemble the meat product being mimicked. The gel matrix may also be formed utilizing an extrusion or co-extrusion process in which multiple gel matrices are combined. Alternatively, the gel matrix may be formed into a round casing, form press or mold. The casing may be plastic, cellulose, alginate or fibrous style. For example, a pepperoni roll may be created and later sliced for use on pizza or as a deli meat.

Alternatively, mixtures or combination of the gel matrix may be used. For example, a first (cooked) gel matrix may be formed utilizing a sous vide process and formed into small particles by grounding, chipping, chopping, dicing or slicing to mimic nuts, nut paste or nut filling. These small particles may be added to an uncooked gel matrix formulation. This provides for the ability to have different color, flavor and/or texture characteristics to provide unique texture, taste, visual variations to the end gel matrix and may be advantageous to people who have nut allergies. Components may be mixed at the time of filling or forming (precook packaging or extrusion). Advantages of substitutions or inclusions may include substitution of gel product to avoid additives that are high in cost, in low availability, or high in bacterial load. Positive gel inclusion properties can include better slicing yields, longer shelf life, and/or better freshness of product. The inclusion of gel in place of typical components may also increase slicing reliability and decrease wet product pockets (when a hole in product occurs on final slicing that is caused by a traditional inclusion, for example a wet pocket around a natural pimento.

Various meat analogs may be provided. For example, a plant-based bacon analog may be provided. A lighter color cooked gel with high fat content may be ground and then added to an uncooked gel formulation so that the lighter color cooked gel matrix functions as the fat visual of bacon analog. Colorants may be added to the uncooked gel matrix meat portion to simulate the color of pork bacon or of turkey bacon. Also, co-extrusion may be used to mimic the stripes in bacon so that there may be light (white) stripes simulating the fat between the pink of the meat portion.

In another example, a plant-based mortadella analog may be provided in which a lighter color cooked gel with high fat content may be ground and then added to an uncooked gel formulation so that the lighter color cooked gel matrix functions as the fatty aspect of the mortadella. An additional gel matrix mimicking pistachio (light green coloring) may be added to further mimic mortadella.

For a plant based olive, pimento and pickle loaf luncheon meat analog, a lighter color gel fat component may be ground after cook for inclusion into/with the uncooked gel matrix to imitate leaner aspects of the portion of the analog meat components where the lighter cooked component functions as the fatty imitative component. An additional gel component may be also added that is similar visually to pickles and/or olives and thus formulated with green visual look. Alternatively an additional gel component may be added to simulate red peppers or red pimentos (red visual look).

Other examples may include: 1) plant-based meatloaf containing about 5 to 10% w/w of a gel matrix; 2) plant-based meatballs containing about 5-10% w/w of a gel matrix; 3) plant-based pepperoni containing about 30% of a gel matrix; 4) plant-based chorizo about 5-10% of a gel matrix, all of which may include specific oil/liquid ratios and spices for the respective products.

The firmness of the gel matrix may vary depending on its end use. A softer gel matrix may be used in certain non-meat base products such as vegan cheeses, cheesecakes, custards whereas a firmer gel matrix may be used in plant-based food products such as meat analogs. In preferred embodiments, the gel matrix has a firmness of at least about a firmness similar to a dairy cheese and often between about the firmness of a cheddar cheese and a harder swiss cheese, for example. Firmness of the gel matrix is often observed in ranges such as those found in firms cottage cheese to a hard-aged cheddar cheese. For example, a gel matrix incorporated into a meat analog may have a similar firmness to aged blocked swiss cheese.

Another aspect of the present disclosure is directed to methods for producing plant-based food products. In one embodiment, the process comprises forming a mixture comprised of about 20% to 80% w/w of a liquid, and about 15% to 50% w/w of a flour, a plant-derived protein or a combination thereof. The mixture may be pressurized within a cooking container heated at a maintained temperature to form a gel matrix to provide a plant-based food product.

The thickness of the mixture may vary depending on the application of the end product (e.g., standalone food product or incorporated into another food product). For instance, the mixture may have a consistency substantially similar to a very light tempura batter to form a soft gel matrix, whereas thicker mixtures may produce a firmer gel matrix.

The mixture may be placed into a cooking container using any known method, including pumping, poring, scooping, and filling the contents into the cooking container. Examples of cooking containers may include chubs, casings, pans, bowls, thermoformer pouches, bags, and sleeves. The contents of the cooking container may be sealed (e.g., via heat sealing, clipping, crimping, or tying the cooking container) and vacuumed to a range between about 10 to 55 mbar.

In some preferred embodiments, the mixture is heated at a maintained temperature via a sous vide process. A typical temperature range may be between about 140 to 210° F. and often between about 160 to 196° F. Cooking times may range between about 15 to 50 minutes. In some instances, longer cooking times may be used for thicker cook shapes and larger mass pieces to cook through to their center. Exemplary sous vide-type cooking conditions are described in U.S. Pat. Nos. 3,966,980 and 10,506,82262 and WO 2014/019018A1, all of which are incorporated by reference in their entireties herein. Various flavorants (e.g., smoke flavors) may be added during the sous vide process.

In some embodiments, the gel matrix formed after preparation may be chilled, frozen or chilled then frozen. For example, a blast chiller to flash chill or freeze the gel matrix may be utilized.

Examples of other heating methods may include steam ovens, spiral ovens, water baths, and kettle cooking. In some embodiments, an extrusion cooking process may be used. For example, the mixture may be cooked simultaneously with pump or screw conveying. Extruding with steam or external heat may also be used for specific product textures, such as pizza crumbles or cooked taco fillings.

In some embodiments, the components for the plant-based food product and its production process may be presented as a “kit and recipe” for the end user. This format may be preferred for meat or food producers that do not have R&D resources, plant-based expertise, or business scale. Moreover, freshness of the end product is increased by adding water and oils later in its assembly, since moisture is required for bacterial activity and oils may start to oxidize or become rancid once incorporated into the final product.

For example, the dry ingredient components for producing a plant-based food product may be packaged partially or completely separately and combined by an end user (e.g., grocer or butcher) or intermediate manufacturer (e.g., grinder/patty makers, commercial butchers) using their liquids and oils combined with dry ingredients and mixed on-site with the pre-produced gel matrix. The gel matrix may then be mixed with meat analogs or other non-meat base products on-site if desired.

In some embodiments, the kit may be a three-part kit. For example, the kit may be comprised of a first dry bag, a second dry bag, and a gel matrix bag. The contents of each bag may all be assembled by the end-user in combination with liquids (e.g., oils, waters) located on-site to form the end product. The recipe, instructions, and component ratios (by weight) of each part may differ depending on the intended end product.

The first dry bag may include dry spices and flour to provide product flavor and specific culinary characteristics for the end product. The first dry bag may include base flours blends, texture items, food safety items, freshness items, basic spice profile and other specific flavors for the end product. The second dry bag may include one or more components to provide specific mouthfeel and textures. In some embodiments, critical formulas, blends, and other formulary properties may be split between the first and second dry bags (e.g., to protect proprietary formulations as trade secrets). The gel matrix bag provides fat and/or fat replacement characteristics (visual fat mimic, fat level, saturated fat level, fat-like mouthfeel) for the end product. For example, the gel matrix bag may include a sous vide cooked gel to be mixed with the components of the first and second dry bags. Once the kit is received, the end user can mix the components of the three bags according to a provided recipe along with the required liquids for product moisture level and oils (e.g., for fat content, mouthfeel, saturated fats).

The following examples are merely illustrative of the invention and are not limiting thereon.

### EXAMPLES

### Example 1: Process for Forming Gel Matrix

Formulation 1 for Meat Fat Alternative
57% w/w water, 33% w/w chickpea flour available from Nutriati, Inc., 8% w/w vegetable oil, 1% w/w salt, 1% w/w flavorings and spices.
Formulation 2 for Meat-fat Alternative
40% w/w water, 20% w/w chickpea flour available from Nutriati, Inc., 10% w/w legume powder, 10% w/w corn starch, 5% w/w whey protein, 5% w/w soy protein isolate, 3% w/w vegetable oil, 5% w/w coconut oil, 1% w/w salt, 1% w/w flavorings and spices.

### Example 2: Plant-Based Burger Patty

The following components are mixed and placed into a cooking container: about 25 to 35% w/w of chickpea protein, about 1 to 5% w/w of coconut oil, about 5 to 10% w/w of sunflower oil, about 1 to 5% w/w of dried porcini mushroom powder, about 1 to 5% of spices and about 40 to 55% of water. The cooking container is placed in a water bath and cooked at a constant temperature of about 170° F. for 120 minutes to gel the mixture thereby forming a gel matrix with a firmness similar to swiss cheese. The gel matrix is ground then mixed with additional ingredients to form plant-based burger patties.

### Example 3: Plant-Based Meatball

The following components are mixed and placed into a cooking container: about 15 to 25% w/w of chickpea protein, about 15 to 25% w/w of chickpea flour, about 5 to 15% w/w of coconut oil, about 1 to 5% w/w of sunflower oil, about 1 to 5% w/w of shiitake mushroom powder, about 1 to 5% w/w of lactic acid, about 1 to 5% w/w of xantham gum, about 1 to 5% w/w of spices and about 40 to 55% w/w of water. The cooking container is placed in a water bath and cooked at a constant temperature of about 195° F. for 45 minutes to gel the mixture thereby forming a gel matrix with a firmness similar to a hard cheese. The gel matrix is then ground and mixed with additional ingredients such as bread crumbs, parsley, flavors, spices, chickpea flour and water to form plant-based meatballs.

Although the present approach has been illustrated and described herein with reference to preferred embodiments and specific examples thereof, it will be readily apparent to those of ordinary skill in the art that other embodiments and examples may perform similar functions and/or achieve like results. By way of example, the plant-based gel matrix described herein is not limited to use with meat analogs or non-meat base products. For instance, the gel matrix may be mixed with animal-containing meat blends. All such equivalent embodiments and examples are within the spirit and scope of the present approach.

Texture challenges are significant hurdles in meat-alternative foods. In another embodiment of a plant-based vegetable patty, the gel is added (4-300% rate) to burger mix for texture and aesthetic enhancement where the patty base contains beans, potatoes, peas, lentils, yarns, or other vegetables that exhibit soft or mushy textures when fully cooked. The gel adds texture which ameliorates the soft textures in the plant-based and vegetables without use of methylcellulose, artificial ingredients, or highly processed additives.

Another significant hurdle in meat-alternative foods is in protein levels. There is a dire in the marketplace for higher protein content. In general grains and vegetables have a lower protein content than meats and this comparison is exaggerated when lower cost sources are examined. In another embodiment, the gel is formulated with protein concentrates (3-15%) and/or protein isolates (1-20%), cooked, and added (5-20% rate) to a falafel mix for texture and protein enhancement.

In another embodiment, the gel is formulated with protein concentrates (3-15%) and/or protein isolates (1-20%), cooked, and added (5-20% rate) to porridge (corn, rice, oats, barley, wheat, other grains or grass seeds) for texture and protein enhancement.

That which is claimed is:

1. A process for producing a firm plant-based food product mimicking characteristics of meat fat comprising:
a) forming a mixture comprised of
i) about 20% to 80% w/w of a liquid, and
ii) about 15% to 50% w/w of a flour, a plant-derived protein or a combination thereof, wherein the flour or plant-derived protein or combination thereof is pretreated by impregnation and enriched with an additive, an amino acid, a peptide, a protein or a dietary supplement;
b) placing the mixture into a cooking container;
c) pressurizing the mixture within the cooking container; and
d) heating the cooking container at a maintained temperature to gel to form a gel matrix to provide a firm plant-based food product mimicking characteristics of meat fat.

2. The process of claim 1, wherein the liquid is selected from the group consisting of water, vinegar, juices, plant milk, plant liquids, alcoholic beverages and combinations thereof.

3. The process of claim 2, wherein the plant milk is selected from the group consisting of grain milk, legume milk, nut milk, seed milk and combinations thereof.

4. The process of claim 1, wherein the flour is selected from the group consisting of grain flour, legume flour, nut flour, vegetable flour, root flour, algae flour, seaweed flour, amaranth flour and coconut flour and combinations thereof.

5. The process of claim 4, wherein the legume flour is chickpea flour.

6. The process of claim 1, wherein the plant-derived protein is selected from the group consisting of whey protein, soy protein, lentil protein, pea protein, seed protein, rice protein, mycoprotein, derivatives and combinations thereof.

7. The process of claim 1, wherein the plant-derived protein is a protein powder selected from the group consisting of protein isolates, protein hydrolysates, protein concentrates and combinations thereof.

8. The process of claim 1 further including forming the mixture with about 1% to 40% w/w of an oil.

9. The process of claim 8, wherein the oil is between about 4 to 20% w/w of the mixture and is selected from the group consisting of almond oil, avocado oil, mustard oil, canola oil, coconut oil, butter, corn oil, cottonseed oil, flaxseed oil, olive oil, peanut oil, rice bran oil, safflower oil, sesame oil, soybean oil, sunflower oil, grapeseed oil, vegetable oil and combinations thereof.

10. The process of claim 8, wherein the oil is selected from the group consisting of almond oil, avocado oil, mustard oil, canola oil, coconut oil, butter, corn oil, cottonseed oil, flaxseed oil, olive oil, peanut oil, rice bran oil, safflower oil, sesame oil, soybean oil, sunflower oil, grapeseed oil, vegetable oil and combinations thereof.

11. The process of claim 1, wherein the additive is selected from the group consisting of antioxidants, extracts, salts, spices, herbs, natural flavors, artificial flavors, cultured products, plant-based heme, colorants, sweeteners, natural preservatives, artificial preservatives, amino acids, fillers, nucleic acids, natural colors, sauces, chopped vegetables, dried vegetables, fruits and combinations thereof.

12. The process of claim 1, wherein the pressure within the cooking container is about 9 to 55 mbar.

13. The process of claim 1, wherein the cooking container is heated between about 135 to 210° F.

14. The process of claim 1, wherein the cooking container is heated for about 15 to 50 minutes.

15. The process of claim 1, wherein the temperature during heating is maintained at a substantially constant temperature using a sous vide process.

16. The process of claim 1 further including incorporating the gel matrix into a plant-based meat or a non-meat base product.

17. The process of claim 1, wherein the firm gel matrix is processed by grinding, slicing, mixing, blending, tumbling, pressurizing, molding or combinations thereof.

18. A plant-based food product mimicking characteristics of meat or meat fat comprising a gel matrix formed from
i) about 20% to 80% w/w of a liquid, and
ii) about 15% to 50% w/w of a flour, a plant-derived protein or a combination thereof, wherein the flour or plant-derived protein or combination thereof is pretreated by impregnation and enriched with an additive, an amino acid, a peptide, a protein or a dietary supplement.

19. The plant-based food product of claim 18, wherein the liquid is selected from the group comprising water, vinegar, juices, plant milk, vegetable liquids, alcoholic beverages and combinations thereof.

20. The plant-based food product of claim 18, wherein the plant milk is selected from the group consisting of grain milk, legume milk, nut milk, seed milk and combinations thereof.

21. The plant-based food product of claim 18, wherein the flour is selected from the group consisting of grain flour, legume flour, nut flour, vegetable flour, root flour, algae flour, seaweed flour and combinations thereof.

22. The plant-based food product of claim 21, wherein the legume flour is chickpea flour.

23. The plant-based food product of claim 18, wherein the plant-derived protein is selected from the group consisting of whey protein, soy protein, lentil protein, pea protein, seed protein, rice protein, mycoprotein, derivatives and combinations thereof.

24. The plant-based food product of claim 18, wherein the plant-derived protein is a protein powder selected from the group comprising protein isolates, protein hydrolysates, protein concentrates and combinations thereof.

25. The plant-based food product of claim 18 further including about 1% to 40% w/w of an oil selected from the group consisting of almond oil, avocado oil, mustard oil, canola oil, butter, corn oil, cottonseed oil, flaxseed oil, olive oil, peanut oil, rice bran oil, safflower oil, sesame oil, soybean oil, sunflower oil, grapeseed oil, vegetable oil and combinations thereof.

26. The plant-based food product of claim 18, wherein the additive is selected from the group consisting of antioxidants, extracts, salts, spices, herbs, natural flavors, artificial flavors, cultured products, plant-based heme, colorants, sweeteners, natural preservatives, artificial preservatives, amino acids, fillers, nucleic acids, natural colors, sauces, chopped vegetables, dried vegetables, fruits and combinations thereof.

27. The plant-based food product of claim 18 further including a plant-based meat selected from the group consisting of plant-based genoa sausages, chorizos, meatloaves, deli meats, burger patties, pepperoni, Italian sausages and meatballs and combinations thereof.

28. The plant-based food product of claim 18 further including an uncoated gel matrix mixed with a cooked gel matrix.

29. The plant-based food product of claim 18 wherein two or more gel matrices are co-extruded.

30. The plant-based food product of claim 18 further including a non-meat base product mixed with the gel matrix.

31. The plant-based food product of claim 30, wherein the non-meat base product is selected from the group comprising jackfruit, tofu, tempeh, seitan and combinations thereof.
